(19) United States
(12) Patent Application Publication
(10) Pub. No.: US 2021/0317804 A1
(43) Pub. Date: Oct. 14, 2021

(54) Fuel Vapor Treatment System

(71) Applicant: AISAN KOGYO KABUSHIKI KAISHA, Obu-shi (JP)

(72) Inventors: Hiroaki KITANAGA, Obu-shi (JP); Yuya TANIDA, Obu-shi (JP)

(73) Assignee: AISAN KOGYO KABUSHIKI KAISHA, Obu-shi (JP)

(21) Appl. No.: 17/227,658

(22) Filed: Apr. 12, 2021

(30) Foreign Application Priority Data
Apr. 13, 2020 (JP) 2020-071548

(51) Int. Cl. F02M 25/08; B01D 53/04

(52) U.S. Cl. CPC F02M 25/0854; B01D 53/0415; B01D 53/0446; B01D 2259/404; B01D 2259/4516; B01D 2259/40086; F02M 25/0836

(57) ABSTRACT

A fuel vapor treatment system includes a plurality of adsorbent sections arranged in series and configured to adsorb fuel vapor, a tank port in fluid communication with a fuel tank, a purge port in fluid communication with an engine, an atmospheric port in fluid communication with a surrounding atmosphere, and a constriction plate disposed adjacent to an atmospheric side end of the adsorbent section of the plurality of adsorbent sections that is most proximal the atmospheric port. The constriction plate is positioned adjacent the adsorbent section without an intermediate space formed therebetween. The constriction plate has a plurality of through holes. The total cross-sectional area of the through holes in the constriction plate is smaller than a cross-sectional area of a flow passage in the atmospheric port.

### CROSS-REFERENCE TO RELATED APPLICATIONS

This application claims priority to Japanese patent application serial number 2020-071548, filed Apr. 13, 2020, which is hereby incorporated herein by reference in its entirety for all purposes.

### BACKGROUND

The present disclosure relates generally to fuel vapor treatment systems.

A vehicle equipped with a fuel tank is typically equipped with a canister to collect evaporated fuel that flows out of the fuel tank when parked or during refueling. This prevents the evaporated fuel from be released into the atmosphere. For example, Japanese Patent Application Publication No. 2016-065463 discloses a canister containing a plurality of adsorbent sections.

The canister of the above publication contains a heating device for heating the air taken in by the atmospheric port. The heating promotes desorption of fuel from the adsorbent section during a purging operation. The heating device includes a heater and a plurality of heat radiating plates. One of the heat radiating plates is extended in length and bent to form an anti-diffusion plate. The anti-diffusion plate has a plurality of holes. The anti-diffusion plate functions to rectify the flow of purge air from the atmospheric port to the heater. The anti-diffusion plate also functions to prevent the evaporated fuel that has passed through the adsorbent section from diffusing toward the atmospheric port when the purging operation is not being performed.

### SUMMARY

One aspect of the present disclosure provides for a fuel vapor treatment system having a plurality of adsorbent sections arranged in series and configured to collect fuel vapor, a tank port in communication with a fuel tank, a purge port in communication with an engine, an atmospheric port in communication with the atmosphere, and a constriction plate disposed adjacent to an atmospheric side end of the adsorbent section. The atmospheric side end of the adsorbent section is the adsorbent section most proximal the atmospheric side of the series. The constriction plate is formed adjacent the adsorbent section without an intermediate space therebetween. The constriction plate has a plurality of through holes. The total cross-sectional area of the through holes in the constriction plate is smaller than a cross-sectional area of a passage in the atmospheric port.

### BRIEF DESCRIPTION OF THE DRAWINGS

FIG. 1 is a schematic, cross-sectional side view of a fuel vapor collecting system according to one embodiment.

FIG. 2 is a perspective view of an embodiment of a constriction plate that can be used in the fuel vapor collecting system of FIG. 1.

FIG. 3 is a perspective view of an embodiment of a constriction plate that can be used in the fuel vapor collecting system of FIG. 1.

FIG. 4 illustrates schematic, cross-sectional views of two types of holes in a constriction plate and corresponding differences in flow depending on the geometry of the holes.

FIG. 5 is a cross-sectional view of a canister model used in a computer analysis wherein the canister has a constriction plate at different positions.

FIG. 6 is a chart illustrating the amount of diffusion when the constriction plate is placed at either position “c” or “d” in FIG. 5.

FIG. 7 is a cross-sectional view of a canister with a single adsorbent section that was used in the performance test.

FIG. 8 is a perspective view of a conventional holding plate.

FIG. 9 is a perspective view of an embodiment of a constriction plate that can be used in the fuel vapor collecting system of FIG. 1.

FIG. 10 is a chart illustrating the amount of breakthrough of butane and its dependence on the hole diameter.

### DETAILED DESCRIPTION

Japanese Patent Application Publication No. 2016-065463 teaches the heating device is situated between the anti-diffusion plate and the adsorbent section. The heating device also requires a space between it and both the anti-diffusion plate and the adsorbent section. Inventors of the present disclosure found that when such a distance exists between the anti-diffusion plate and the adsorbent section, the anti-diffusion effect is diminished. This is especially evident when only a low rate of flow, such as due to spontaneous diffusion, is present. Such a low rate of flow may occur when a vehicle is parked. Further, inclusion of the heating device and spacing between the heating device and both the anti-diffusion plate and the adsorbent section results in an increase in the canister size. Therefore, it is desired to solve at least one of the above problems.

Embodiments of the present technology will be described below with reference to the drawings. Similar and/or corresponding features will be designated by similar reference numerals.

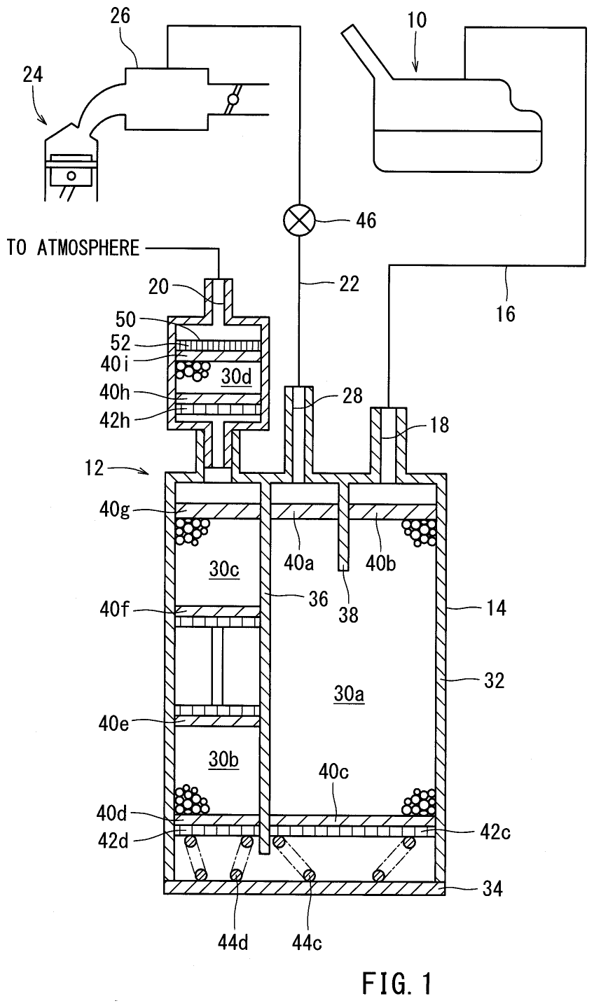

FIG. 1 shows a canister 12 mounted on a vehicle, such as an automobile. The canister 12 collects excess fuel vapor from the fuel tank 10. The canister 12 includes a casing 14 having a tank port 18 in fluid communication with the fuel tank 10 via a line 16, an atmospheric port 20 in fluid communication with the surrounding atmosphere, and a purge port 28 in fluid communication with an intake line 26 of the engine 24 via a purge line 22. The canister 12 contains at least one adsorbent section (four adsorbent sections 30a-d are shown in this embodiment) arranged within the casing 14. Each adsorbent section comprises a volume of granules of an adsorbent, such as activated carbon. For example, the casing 14 contains first to fourth adsorbent sections 30a-d, respectively, arranged in series along a flow passage extending from the tank port 18 to the atmospheric port 20. In this case, the fourth adsorbent section 30d is closest to the atmosphere (via atmospheric port 20), and may also hereinafter be referred to as the final adsorbent section.

Referring to FIG. 1, the casing 14 of the canister 12 is constructed of a casing body 32 and a closure 34 that closes the opening of the casing body 32. The inside of the casing 14 is generally divided into two chambers, one on the tank side (in direct fluid communication with the tank port 18) and the other on the atmospheric side (in direct fluid communication with the atmospheric port 20). The casing 14 is divided into the two chambers by a partition wall 36 unitarily formed with the casing body 32, thereby defining a generally U-shaped flow passage in the casing 14. For example, as shown in FIG. 1, the first adsorbent section 30a is positioned in the tank side chamber, and the second and third adsorbent sections 30b, 30c are positioned in the atmospheric side chamber. The casing 14 may include an independent chamber for the fourth adsorbent section 30d. In this embodiment, the casing 14 includes a buffer wall 38 that prevents direct fluid communication between the tank port 18 and the purge port 28. The configuration of the casing 14 and the adsorbent sections 30a-d described above and shown in FIG. 1 is merely according to one specific embodiment. In other embodiments, the number, arrangement, and locations of the adsorbent sections can be altered in various ways.

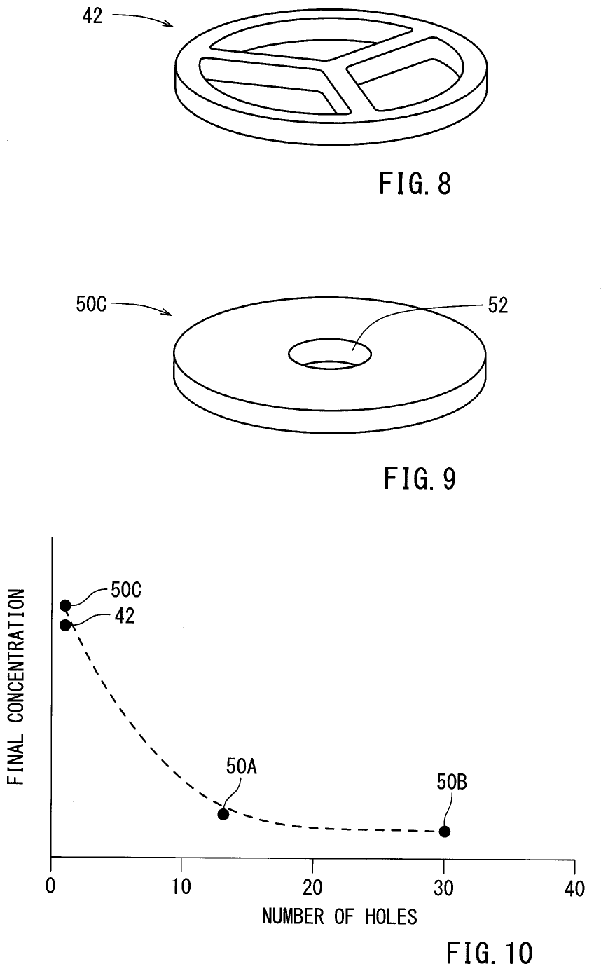

In this embodiment, filters 40a to 40i are placed on the ends of the adsorbent sections 30a-d to hold the granular adsorbents in place. The filters 40a to 40i may be air-permeable sheets made of a porous or fibrous material, such as a non-woven fabric or a polyurethane foam. Holding plates 42c, 42d, 42h are placed on the outer sides of (below in FIG. 1) the filters 40c, 40d, 40h, respectively. Each of the holding plates 42c, 42d, 42h may be a plate with a coarse opening or a hollow frame. The holding plates 42c, 42d, 42h may be configured such that they do not prevent fluid flow, such as those with the structure shown in FIG. 8. Springs 44c, 44d are disposed between the holding plates 42c, 42d and the closure 34. The holding plates 42c, 42d are pressed against the adsorbent sections 30a-c by the springs 44c, 44d to allow for changes in the volume of the adsorbent sections 30a-c over time. The holding plates 42c, 42d, 42h may be omitted if the adsorbent material can be held only by the filters, such as the filters 40a, 40b, 40g. In another embodiment (not shown), the filter may be omitted if there is minimal possibility that adsorbent granules would escape through the holding plate.

During refueling or when parked, evaporated fuel may flow from the fuel tank 10 through the tank port 18 and into the canister 12. The evaporated fuel is then adsorbed in the adsorbent sections 30a-d. While the engine 24 is operating, air is drawn into the canister 12 from the atmospheric port 20, due to the negative pressure of the intake line 26. This causes the fuel adsorbed in the adsorbent sections 30a-d to be desorbed (i.e., the canister 12 is purged). The desorbed fuel is then discharged from the purge port 28. This purge operation may be appropriately controlled by a purge control valve 46 provided along the purge line 22 extending from the purge port 28.

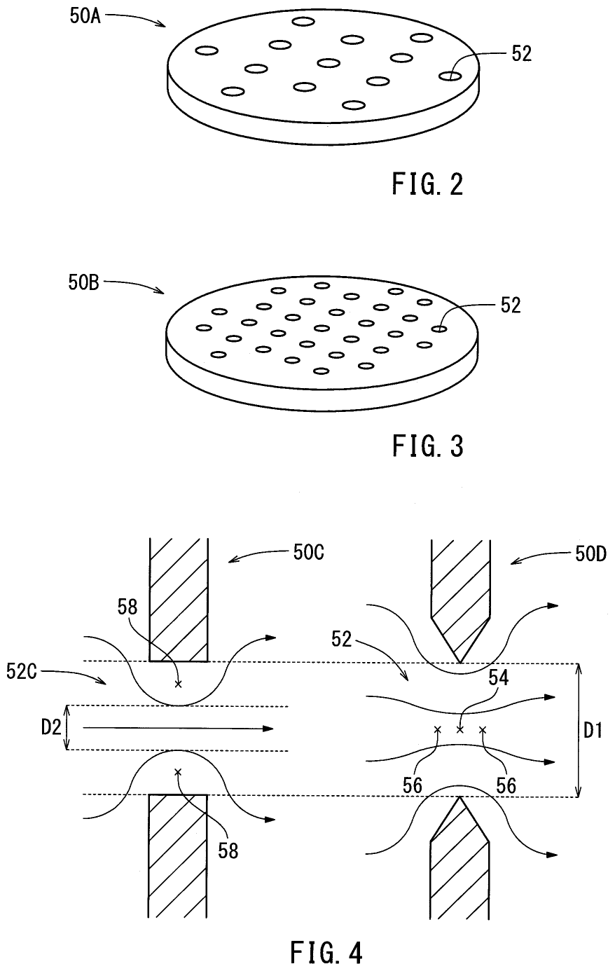

Still referring to FIG. 1, a constriction plate 50 having a plurality of holes 52 is positioned adjacent to the atmospheric side end of the final adsorbent section (the fourth adsorbent section 30d in the embodiment shown in FIG. 1). The constriction plate 50 may be arranged so that there is not a space between the constriction plate 50 and the final adsorbent section 30d. However, as described above, the filter 40i may cover the end surface of the final adsorbent section 30d, between the final adsorbent section 30d and the constriction plate 50. In this case, the canister 12 may be structured such that there may be no space between the constriction plate 50 and the filter 40i. The constriction plate 50 is preferably made of plastic. However, other suitable materials can also be used. FIGS. 2 and 3 show constriction plates 50A, 50B, respectively, according to specific embodiments.

The total cross-sectional area of all of the plurality holes 52 in the constriction plate 50 may be equal to or less than the cross-sectional area of the interior passage defined by the atmospheric port 20. Accordingly, the constriction plate 50A, 50B may have a constricting effect on flow through the flow passage defined by the adsorbent sections 30a-d. This is especially the case when the flow rate is low, such as when there is only a flow caused by spontaneous diffusion due to a concentration gradient. The constriction effect thus delays diffusion of the fuel vapor from the final adsorbent section 30d toward the atmospheric port 20. Consequently, the constriction plate 50 reduces the diffusion of fuel vapor into the atmosphere while a purging operation (desorption) is stopped. Accordingly, this reduces emission of fuel vapor due to temperature changes when parked, such emissions being known as diurnal breathing losses (DBL).

The diameter of the holes 52 may be 3.0 mm or less. When the holes 52 are not circular, the diameter of a circle that has an equivalent cross-sectional area to such non-circular shape can be defined to be its diameter. Diameters within the above range offer the potential effectively reduce breakthrough of fuel vapor into the atmosphere. The holes 52 may have the same or different diameters. The number of holes 52 can be determined in consideration of, for example, the flow resistance of the entire flow passage, provided that the above conditions of the total area and diameter of the holes 52 are satisfied.

Referring now to FIGS. 2 and 3, embodiments of constriction plates 50A, 50B that can be used as the constriction plate 50 shown in FIG. 1 are shown. It is preferable that the holes 52 are dispersedly arranged in the constriction plates 50A, 50B, and preferably as uniformly as possible. Such a uniform distribution rectifies purge air drawn into the canister 12 from the atmosphere. The rectified purge air then passes through the adjacent final adsorbent section 30d, thereby allowing uniform desorption from the entire cross section of the final adsorbent section 30d.

As shown in the right part of FIG. 4, a hole 52 may widen or flare from its middle portion 54 to each of opposite end openings 56. Each of the end openings 56 open in a side of the constriction plate 50D, as viewed in the axial direction of the hole 52. As shown in the left part of FIG. 4, when the cross-sectional shape of a hole 52C in the constriction plate 50C is constant between the end openings (e.g., the hole may have a cylindrical shape), the gas flow passing through the hole tends to concentrate about the central axis of the hole 52C. This concentration about the central axis of the hole 52C creates a dead zone 58 close to the circumferential wall surface defining the hole 52C. The effective diameter D2 of the hole 52C is thus considerably smaller than the actual diameter D1. In contrast, as shown in the right part of FIG. 4, the hole 52 in the corresponding constriction plate 50D widens from the middle portion 54 to each end opening 56. This allows the flow to spread toward the wall surfaces defining the hole 52, so that the effective diameter of the hole 52 approaches the actual diameter D1 (as measured at the middle portion 54) of the hole 52. This may result in a reduced flow resistance across the constriction plate 50D during a high rate of flow. The high rate of flow may be from purge air during a purge operation or excess fuel vapor during refueling.

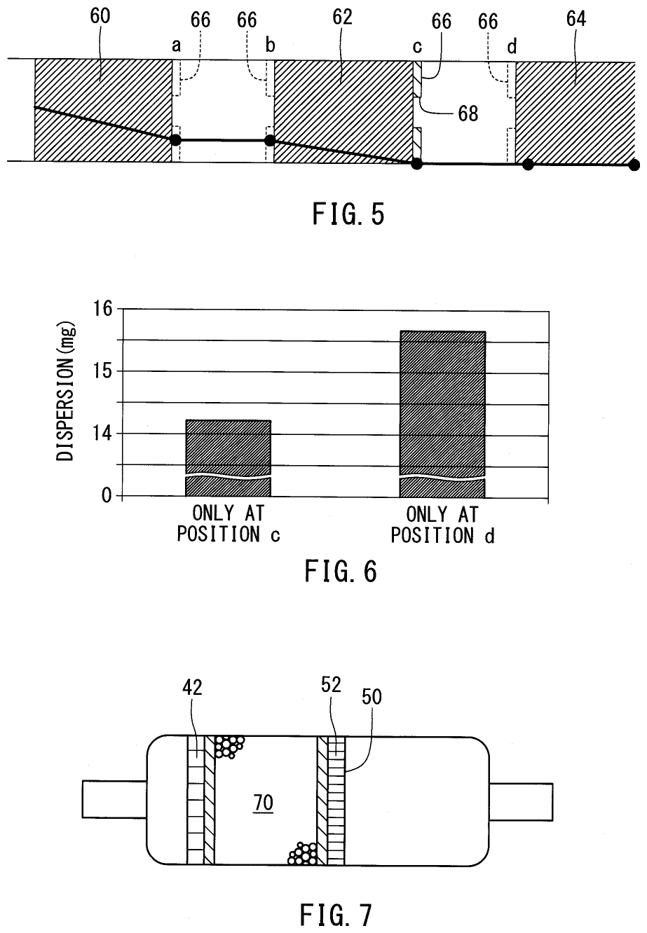

A computer analysis (CAE) was performed to examine how the changes in the amount of breakthrough depends on the position of the constriction plate with respect to the adsorbent section. As shown in FIG. 5, a canister model was created, where the canister included two adsorbent sections 60, 62 and a trap section 64 for detection. The two adsorbent sections 60, 62 and the trap section 64 were arranged in series in a flow passage extending from a tank side (left end in FIG. 5) to a atmospheric side (right end in FIG. 5). The flow passage had a length of 140 mm and a cross-sectional area of 86 mm². A constriction plate 66 having only one hole 68 in the center with a diameter of 19.7 mm was set along the flow passage. The constriction plate 66 was positioned at each of four different positions a to d along the flow passage for comparison. Position a is the downstream end of the first adsorbent section 60 (the right or atmospheric side of the first adsorbent section 60). Positions b and c are the ends of the final adsorbent section 62 (the left and right ends or the tank side and the atmospheric side, respectively, of the final adsorbent section 62). Position d is immediately before the trap section. An initial concentration was provided on the tank side (left end in FIG. 5), and the process of soaking (diffusion) was simulated for 12 hours, 24 hours (1 day), and 48 hours (2 days). The concentration of fuel collected in the trap section was then determined. Soak means to allow the concentration to take its own course. Thus, during the soak, the distribution of concentration within the casing changes due to diffusion. The thick line overlaid in FIG. 5 is a graph of an exemplary concentration distribution after a soak.

The test results show that the amount of diffusion into the trap section was the smallest when the constriction plate 66 was placed at position c. This was the case for all of the soak times. As shown in FIG. 6, when the constriction plate 66 was placed at either of positions d or c, the amount of diffusion after 48 hours was below 20 mg, which is a limit value according to certain regulations on evaporative emissions. However, the amount of diffusion when the constriction plate 66 was at position c was smaller than that when it was at position d. It is believed that this difference would be greater as the soak time is prolonged. When the constriction plate 66 was at either of positions a or b, the amount of diffusion after 48 hours was over 300 mg, which greatly exceeds the regulatory limit value of 20 mg. It was found from these results that when a constriction plate 66 at the end of the final adsorbent section on the atmospheric side is positioned with no intermediate space therebetween, diffusion through the final adsorbent section is reduced. It is was also found that when a constriction plate 66 is placed at position d, diffusion into the space was more likely to occur because of the space between the constriction plate 66 and the final adsorbent section.

Another test was conducted in which the constriction plates 66 were placed at two or more positions. The results showed that when one constriction plate 66 was placed at position c and a second constriction plate 66 was placed at one other position, with the diameter of the holes of both constriction plates 66 being 23.2 mm so that the overall flow resistance was the same, the amount of diffusion was larger than in the case where only one constriction plate 66 placed at position c was used. Further, when constriction plates 66 were arranged at all positions a to c, with the diameter of the holes of each constriction plate 66 being 27.1 mm so that the overall flow resistance was the same, the diffusion also increased. It was found from these results that under the condition that the flow resistance of the entire flow passage is constant, diffusion is reduced to a greater extent when only one constriction plate 66 having smaller diameter holes is placed at the atmospheric side end of the final adsorbent section. For instance, the diffusion increases when more than one constriction plate 66, each having larger diameter holes, are placed at various locations.

Constriction plates having holes with different diameters were prepared. The total cross-sectional area of all the hole(s) of each constriction plate was set to be constant. These constriction plates were used as a constriction plate 50 on the atmospheric side of a canister having a single adsorbent section 70 as shown in FIG. 7 in order to conduct a performance test. A plate with smaller diameter holes 52 had more holes 52. Specifically, the three types of constriction plates 50A, 50B, and 50C, shown in FIGS. 2, 3, and 9, respectively, were used. The diameters of the holes 52 of the constriction plates 50A, 50B, and 50C were 3 mm, 2 mm, and 11 mm, respectively. In order to keep the total cross-sectional area of the holes constant (about 94 mm²), the constriction plates 50A, 50B, and 50C were provided with thirteen, thirty, and one hole(s), respectively. In each case, a conventional holding plate 42, as shown in FIG. 8, was placed on the tank side of the adsorbent section 70. The same type of holding plate 42 was also used as a fourth type of constriction plate 50 on the atmospheric side for comparison. The total cross-sectional area of the voids in the holding plate 42 was 962 mm², which is equivalent to a single circular hole with a diameter of 32.7 mm. The test procedure was formulated in accordance with the test method adopted in an actual regulatory test on evaporative emissions. First, a 50% mixed gas of butane and nitrogen was adsorbed at a flow rate of 40 g butane per hour until a breakthrough of 2 g was reached. Then, the system was allowed to soak for 1 hour. Next, 250 L of dry air was flowed through at a flow rate of 22.7 L/min for purging. The system then soaked again for 1 hour. Then, 1 L of nitrogen was flowed at 0.1 L/min to desorb the butane. The concentration of butane in the gas that had been flown through was measured. As shown in FIG. 10, the result shows that when the diameter is reduced to 3 mm, as in the above-mentioned constriction plate 50A, the amount of breakthrough is reduced by about 25% (please note that the lower end of the vertical axis of the chart does not correspond to 0). However, when the diameter is further reduced, as in the previously mentioned constriction plate 50B, the reduction in the amount of breakthrough levels off.

Although specific embodiments have been described above, the present disclosure is not limited to those embodiments. Accordingly, various modifications, replacements, and/or omissions of features are possible without departing the spirit of the technology.

What is claimed is:

1. A fuel vapor treatment system, comprising:
a plurality of adsorbent sections arranged in series and configured to adsorb fuel vapor;
a tank port in fluid communication with a fuel tank;
a purge port in fluid communication with an engine;
an atmospheric port in fluid communication with a surrounding atmosphere; and
a constriction plate disposed adjacent to an atmospheric side end of the adsorbent section of the plurality of adsorbent sections that is most proximal the atmospheric port without an intermediate space formed therebetween, wherein:
the constriction plate has a plurality of through holes, and
a total cross-sectional area of the through holes in the constriction plate is smaller than a cross-sectional area of a flow passage through the atmospheric port.

2. The fuel vapor treatment system according to claim 1, wherein:
each through hole of the constriction plate has an opening at each opposite end of the through hole and has a middle portion between the openings, and
each through hole widens moving from the middle portion toward each opening.

3. The fuel vapor treatment system according to claim 1, wherein a diameter of at least one of the through holes is 3.0 mm or less.

4. The fuel vapor treatment system according to claim 1, wherein a diameter of each through hole is 3.0 mm or less.

5. The fuel vapor treatment system according to claim 1, wherein a middle portion of each through hole has a cross-sectional area that is less than a cross-sectional area of a distal end of the corresponding through hole.

6. The fuel vapor treatment system according to claim 1, wherein a cross-sectional area of at least one of the through holes is 7.1 mm² or less.

7. The fuel vapor treatment system according to claim 1, wherein a cross-sectional area of each of the through holes is 7.1 mm² or less.

8. The fuel vapor treatment system according to claim 1, wherein a cross-sectional area of at least one of the through holes is 7.5% or less of a total cross-sectional area of the through holes in the constriction plate.

9. The fuel vapor treatment system according to claim 1, wherein a cross-sectional area of each through hole is 7.5% or less of a total cross-sectional area of the through holes in the constriction plate.

10. The fuel vapor treatment system according to claim 1, further comprising a filter disposed between and directly contacting the constriction plate and the atmospheric side end of the adsorbent section of the plurality of adsorbent sections that is that is most proximal the atmospheric port.

11. The fuel vapor treatment system according to claim 1, wherein the intermediate space is an air gap.

12. The fuel vapor treatment system according to claim 1, wherein a filter or an air gap is formed between the constriction plate and the atmospheric port.
